(19) United States
(12) Patent Application Publication
(10) Pub. No.: US 2004/0143509 A1
(43) Pub. Date: Jul. 22, 2004

(54) Centralized negociation and offer system and respective operational methods of offer, businesses and mercantile activities process applied to productive sectors

(76) Inventors: Joaquim Antonio De Almeida Prado, Sao Paulo (BR); Edison Viriato, Sao Paulo (BR); Eneas Viriato, Sao Paulo (BR); Roberto Mauri Cardoso, Sao Paulo (BR)

Correspondence Address: STEINBERG & RASKIN, P.C., 1140 AVENUE OF THE AMERICAS, 15th FLOOR, NEW YORK, NY, 10036-5803, US

(21) Appl. No.: 10/475,796

(22) PCT Filed: Oct. 25, 2001
(86) PCT No.: PCT/BR01/00135

(30) Foreign Application Priority Data
Apr. 23, 2001 (BR) PI 0101836-1

(51) Int. Cl. G06F 17/60

(52) U.S. Cl. 705/26; 705/35

(57) ABSTRACT

The operational system is characterized by presenting a structure formed by a Centralized Negotiation System: (1), subject to be developed through BDAs (2) and simultaneously be connected (3) to Productive Market Institutions (4) formed ideologically by Selling agents (5) and Purchasing agents (6), being that all this interconnection is self-regulated, institutionally, by a Private Authority (7) and, businesslike, by an Operating Center (8), using the Financial Institutions (9), especially Banks and Insurance institutions (10) which, together with single Companies, act as Guarantors (11) of mercantile bonds issuing (12) or other ways for the settlement of these Mercantile Bonds, with auxiliary service renderers, and mainly acting as a dynamic and Contextual Mercantile System, in which each operation involved in negocation process.

### INVENTION FIELD

The present Invention Patent deals with the development of a centralized negotiation and offer system and respective operational methods of offer, businesses and mercantile activities, this system is applied specifically to juridical, technical, operational, commercial, market, technological, administrative, economical and financial aspects of a Private System of incentive to mercantile and economical activities and to productive sectors competition: agricultural, mineral, energetics, industrial, commercial and services. The referred operational system uses as main tool, within Information Technology scope, several systems and computer and communication electronic infra-structure, such as Internet, Extranet, Intranet and other access, processing, and information data reception and transmission means.

### INVENTION SUMMARY

It is based on a centralized operational structure integrated and dedicated to specialized services rendering oriented to production and development of mercantile activities of productive sectors where the referred structure:

a) Makes available organized forms of purchase and sale offer negotiation of tangible and intangible goods (Assets, Products and Services);

b) Employs suitable negotiation models to each productive sector, regardless its kind, belonging to primary, secondary, tertiary or quaternary market;

c) Uses for that, as Juridical-Business Instrument, Guaranteed Bonds/Mercantile Contracts which are substanced in Assets, Products and Services hereby called “goods”;

d) Operates in an advanced communication and processing built-in technological platform, which is innovating and in line with the state-of-art Information Technology Trend in all its structural, technical, operational, functional and commercial aspects;

e) Supports a set of Standards, Patterns, Rules, Procedures and Services which rule all goods purchase and sale offer, their negotiation and respective financial and physical settlement, guarantees and ownership, granting them high security level, reliability, liquidity and operational integrity; and

f) Uses as strong Technical-Commercial Instrument a board of Business Development Agents, hereby mentioned as BDA or BDAs, natural people or legal entity, autonomous, whose function is to divulge and sell the System's services, as well as to support and orientate its users.

The present System allows the productive market companies to carry out both the trading of their goods, as well as the working capital financing for their businesses, as the result of an adequate trading of their goods using for that: the technique of selling first and producing afterwards; with advanced technological platform within the Information Technology; innovating mechanism of goods purchase and sale offer centralization; self-regulation private structure, specific for productive market; complete set of support ancillary services to goods negotiation, with strong emphasis on the management capacity suitable to the globalization process; creative and innovating process modeling oriented exclusively to the direct negotiation between Purchaser (buyer) and Seller; of the Interconnection of Purchasers and Sellers, regardless physical and geographical places where they are, through the most varied systems of public or private access, processing and communication, such as: Internet, Extranet and Intranet, among others, employed for that, data and information reception and transmission means based on optical and or electromagnetic, digital or analog systems or other deriving ones, under the same or different technologies, through physical loops or not, of any nature or others which may arise for this purpose; of universal system of guarantee to give credibility to global mercantile negotiations of productive market companies; automated processes which provide conditions of equal negotiation to micros, small, medium and big companies.

Based on the context of each negotiation and not exclusively on the kind of product or the qualification of Purchaser and Sellers clients, what differs the present system from all the other ones existing available in the market, making it absolutely innovating and singular before the others.

The project of this Information Era must take into account the social-philosophical transformations occurred, giving priority to the “polyvalent” profile solutions which contain superior added values and the proposals which open ways and alternatives by themselves, and which enable the demonstration and choice of directions, in a last case, by the human clients users themselves.

This is the fundamental point of the present System when focusing the productive process final point: The Trade, which is the common activity to all productive sector of goods (assets, products and services) all these are production results and the real generator of the human kind social wealth.

This focus provides a function innovating specialization which generates a harmonic set of essential activities to the productive process and which are based on opportunity multiplying vectors, in which the present System called Centralized Negotiating System, hereafter mentioned only as CNS, being that the only one qualified with appraisal, suitable tooling and structure to the Production trading process, proposing to act, participating of the global effort to improve the human kind life quality.

It can be mentioned as main characteristics of the present CNS:

a) Time gain on the mechanical and repetitive tasks, through the automation obtained with business management computing, auxiliary of mercantile negotiation and decision processes;

b) Stimulation of commercial relationship interactivity and connectivity of the companies among themselves and the interactivity and connectivity the companies with the financial markets self-regulation and standardization process;

c) Impulse to the knowledge and the education with big intensity in the business training, formatting, business and professional formation and qualification;

d) Bigger and better distribution of income by the access facility of micros, small and medium companies to new global business opportunities;

e) Optimized use of several human capacities and their potential through process modeling, which respect and stimulate the beneficial creativity to human being;

f) Access to more competitive prices by the diffusion of business offers;

g) Quickness on the business management decisions by the carrying out and instant disclosure of the offered and carried out businesses in the negotiation System, composing public and reliable referential to all market agents and Government themselves;

h) Ethic in the business by utilization of a private binary structure represented by a Private Authority named Institute of Mercantile Standards—IMS, responsible for the standards and practices of market self-regulation and by an Operator, responsible for the Centralized Negotiation System of goods purchase and sale offer, this System is marked by the complete equality of opportunities of negotiating parties;

i) Respect to nature represented by echo-systems and human kind natural patrimonies by the demand of negotiation of only goods, which are compliant to the national and international standards to protect the environment, wild life and human kind;

j) Emphasis on the content and not on the form, by the simplification of access means to the negotiation, in both filing, as well as the issuance of Mercantile Bond (explained ahead) as the negotiations themselves;

k) Stimulation to mediations and not conflicts, by means of Institute of Standardization and by the Self-regulation, as well as the recovery of Mediation Institute and of the Arbitration, speeding up technical or commercial dispute solutions and relieving the judiciary power in the treatment and execution of these lawsuits, all through a Private Authority, the Institute of Mercantile Standards—IMS, one for each country.

l) Respect and stimulation of local culture by the easy and compulsory adaptability to their processes to uses and costumes of each country, geo-economical region or market;

m) Integration and interaction of different productive segments and markets, by both the convergence of several technologies as well as the elimination of borders among several productive sectors, by the special modeling of “reality intelligence” of trading processes within each business context, comprising any kind of goods; and

n) Reduction of distances between the producer and consumer by the centralization and consequence pluralization of goods purchase and sale offer and by the access facility to micro, small, medium and big companies to the opportunities offered by globalization.

All that, without any doubt, aiming at a more balanced economy and human kind development, as part of a strategy for a big life quality jump of mankind and its art, what we call Civilization.

The present CNS proposes a simple and rational solution. Which is to act on the Production trading, be agricultural, mineral, energetics, industrial, commercial, scientific, cultural, intellectual, sports, leisure or services.

Such action is not proposed only on the optimization and potentialization, but, the same way, on the effective carrying out of profitability, real stimulation of professional, personnel and business practice and consequently, the economy expansion, new businesses, generation of new work openings, etc.

This profitability will depend on the capacity and effort of each productive agent, what will make sure such efforts will be rewarded by a good trading and not swallowed by interests and incident financial charges.

Thus, behind the strengthening of the present CNS, there will be a two structures: one of Negotiation Standardization (Private Authority, the Institute of Mercantile Standards) and other of Negotiation Operation, which will favor the business mercantile aspects, comprising indifferently all companies from the smallest to the biggest one.

It is also necessary to take into account the present company's reality and the market professional technical-managerial capability level, especially business people and their administrators who are hold up by old-fashioned management processes which respond for the huge rate of liquidation and insolvency of companies, including the traditional ones.

It is inadmissible that businesses, done through Internet, in most of the Latin-American and third world companies are done only locally, where they are located, or when at most to a regional extent. It is incoherent to talk about globalization to such companies and their managers when we do not have a real understanding of its dimension, its impacts and its consequences.

The present CNS solves this problem, making the connectivity and interactivity of the Buying and Selling markets “online” in real time, multiplying the goods purchasing and selling offers, breaking the barriers of time and space and the web which unable the access to micro, small medium and also big companies to good market opportunities, and promoting under all aspects a real “just-in-time” of markets and businesses in all productive chains belonging to any economical segments.

The present System provides beneficial actions on all social levels, meeting man's primary needs: food, health and education, cleaning up in a fair and worthy way, the whole social levels and enabling man's whole development and creation: The Civilization. As consequence, this action will affect the State and its structures, which will be compelled to efficiency, effectiveness, morality and discipline in the correct administration of human, administrative, economical and public finances resources, since the new business class will not depend on the State any longer and will demand retribution for the paid taxes.

Within this inefficient administration focus, there is also the drastic reduction of inflation. Entrepreneurs that have developed a relatively effective mechanism to deal with inflation, not knowing how to or not being able to control costs variable they acted on the other variable: the revenue one, increasing prices to an extraordinary high extent, earning on stocks and on financial market.

The inflation control, unpostponable request has surprised the business community and their administrators without any culture of healthy business administration: planning, budget or price quote, cost control, quality assurance. It would not help, however, to allocate financial resources without accomplishing the professional and business qualification and also of their administrators.

The withdrawal of the State/Government Entity from the economical process is a mark on the developing countries' economy. Though, such fact, has brought a serious problem to the companies and to markets with the state deregulation, in other words, the entrepreneurs previously dependent on the state protection now need to be bound to an organized private system, working by self-regulation.

The market regulation and the recovery of healthy trade practices, with the Mediation and the Arbitral Judgement, for instance, the ones existent in the present CNS, demand an institutional private structure which is reliable, respectable and responsible, which has representativeness and public faith, aiming at a healthy and consensual development of companies and market, besides as for the registration of Mercantile Bonds and businesses and to the respective rules and procedures, and that is, at the same time, a strong market speaker before the State and besides before international regulating organisms.

Such providence solves, at the same time, another big problem in the third world sale of goods: the negotiation credibility lack that is the enormous hindrance to place those goods in the global market.

The present CNS removes those negative sides, creating a strong institutional structure, called Institute of Mercantile Standards—IMS, that is Private Authority, another innovating item of the present System, which is managed by the market itself, through Thematic and Sector Chambers, which, in turn, are Production arms in the ruling and self-regulation process. Through them the productive market is no longer the last one of its history and is presented and takes place as a permanent and dynamic transforming agent of the third millennium society, considering the peculiarity of each country and of each market place.

With those reality aspects comes another, which, in spite of affecting all world markets, it becomes inhumane in the third world in general: the “financerization” of the Production, or rather, the social object generating profitability in the Financial Market, where the “financing”, that is, the loan is sold as the only and effective working capital solution to the productive market. Therefore, “financerization” in this context is the prevalence of the financial aspect over the mercantile aspect of the production.

The Production market, actually, has another profit generating objective, which is: the good and correct trading of its products. Therefore, the “financing” as loan for the Production is based on a mean-activity, not at an end-activity of Production, that is, it is just one more of the several working capital options for its business, not the only one.

The present CNS is, therefore, assembled in this feature: the trigger trading of multiple solutions for the crossroads in which the Latin-American, Brazilian and world production of goods.

At the same time, this solution meets, more than any other, the need to supply the financial market with a reliable Asset Bond which is the Mercantile Bond substanced in Assets, Products and Services, which can be carried (financed) by Pension Funds, Financial Funds, Insurance Companies Portfolios, Social Funds, Pension Funds, in Brazil, USA and other countries for instance, replacing Liability Bonds of their application portfolios.

The referred Mercantile Bond is Juridical-Business Instrument through which is done all and any form of goods negotiation represented by Assets, Products and Services, in CNS.

As that Juridical-Business Instrument is the link between the productive physical market of goods (assets, products and services), and the financial market, it was chosen to call it Bond, which is the nomenclature used to identify several papers, exclusively financial ones, negotiated in this financial market, with the increment of the Mercantile term to differentiate it from any other and make it clear that it is about specific negotiation with goods of the productive physical market.

Through the Mercantile Bond it is possible “to commoditize” any type of Production goods, enabling, in an standardized way, its negotiation: offer, purchase and sale, carried out in a purchase and sale offer centralized system via an available modern, evolutionary and efficient tooling, provided by Information Technology.

That Juridical-Business Instrument, the Mercantile Bond, is used in CNS for the negotiation of any type of goods from Production Market and also in any productive phase process.

It is understood here as good the Production result which is the commerce object everything bought and sold. Or, more specifically, it is understood by goods, Assets, Products and Services produced by the Production whether agricultural, mineral, energetics, industrial, services, scientific, cultural, intellectual, leisure or sports, among others.

Those goods represent the objectives of productive organizations, goods that add substantial and beneficial values to the Human Society.

The Mercantile Bond, therefore, is a Bond substanced in goods, which represent real property assets, as the products generated by Production are. The obligations and liability rights are not included in this classification. The mercantile operation has two unique parts involved: the Buying part and the Selling part. Consequently, the Mercantile Bond can be a Purchase Mercantile Bond or a Sale Mercantile Bond.

The Purchase Mercantile Bond is the one whose Buying issuer negotiation intention is represented by the goods purchase intention; the strong offer is represented by the purchase strong offer; and the business settlement is accomplished with to counter-part represented by a Seller and the transfer of the negotiated good's owner name is carried out from the Seller, former owner to the Purchaser, new owner, not being allowed in CNS, the good property transfer by only endorsing the Mercantile Bond.

The Sale Mercantile Bond is the one negotiation intention of issuer/owner is represented by the good sale intention; the strong offer is represented by the sale strong offer; the business settlement is carried out with the counter-part represented by a Purchaser and, in the same way mentioned above, the negotiated good's owner name transfer is carried out by the Seller, former owner to the new Purchaser.

It is a pre-condition, for both Purchase Mercantile Bond as well as for the Sale ones that the Mercantile Bonds are issued and registered in CNS, only after the respective guarantees for the contract accomplishment. They are, therefore, offered and negotiated in CNS with the guarantees duly given by the parties: Purchasing and Selling Parties.

All offered Mercantile Bonds have a Guarantor for both, the goods delivery on the sale side, as well as the good payment, on the purchase side. This arrangement enables and facilitates the goods negotiation in a centralized purchase and sale system, of national and international extent.

Besides the benefits already presented above, there is another great advantage for Production in the trading with the Mercantile Bonds that is the possibility of doing business with Mercantile Bond for the obtaining of new financing sources and of working capital addressed for Production, through the connection with the financial market, whose new exponents in the market financing are the already mentioned Financial Fund and Pension Funds, which can inject resources directly into Production, through those Mercantile Bonds, especially created and treated to make the bridge between the financial market and the productive one, with evident advantages for both sides: for Production, new options of financing sources, for Funds and for Financial Market in general, safer investments in real property assets papers, diversifying and reducing the current risk of exhibiting its liabilities papers portfolio, besides investing in the Countries' wealth generation, the Production, real generation of jobs, income and social benefits.

The Mercantile Bond structure and the treatment given to it in CNS enable several practical applications to several productive segments, enabling its negotiation in a purchase and sale offer centralized system in general, as well as its negotiation in specific and personalized system according to the context of a certain market segment with easy structural adaptation or, still in an exclusive negotiation dominium of only a “Private Market Place”, where only one company does its own business network integrating, in the inputs ends, the suppliers or, in the sale end, integrating customers or from both ends, speeding up its trading.

The offered solution is to complement, replace the traditional Liability Bonds, of long date financed by the financial market, with the Assets Bonds, as the Production ones are, generators of the society's wealth, a simple, natural, intelligent and healthy mechanism of real promotion and increase of national income distribution among the population and among the countries themselves, and that tries the reduction and or elimination of the existent inequalities.

These Mercantile Bonds, mainly the ones of effective future physical delivery or forward, enable renewed connection between the productive market and its several segments and from them to the financial market, in more suitable bases with the interest of Society as a whole.

This factor is real healthy return to the origins, since currency created as a productive market complement, facilitating the trading of goods and, consequently, the income distribution, constituted its own market, the financial one, that, gradually, became an end itself, getting more and more distant from Production and for that reason contributing to a disastrous income concentration process, that is exhausted.

The present CNS is in favor of Production and, therefore, of Society, when offering Mercantile Bonds, representative of goods, substanced in Assets, Products and Services, is also in favor of the financial market. While the market is, directly or indirectly linked to productive market, the evolutionary process will be harmonic, healthy, effective and perennial.

### Invention Bases

The trading of agricultural products is in the base of the human kind development, constituting what we usually call civilization.

Just as illustration, we know that the creation of agriculture ten thousand years ago altered the structure, which characterized man's survival in the search for food. The beginning of civilization appeared there with man's establishment in the field, the population boom and the consequent need for more food and more lands, becoming these ones a symbol of power; therefore, the invention of the agriculture was the pillar, the support of the human kind's development.

At a certain moment, the mercantile exchanges IQ appeared, that is, the beginning of trading, and, later, with the currency, the trade of production means with the purchase and sale of goods. Thereafter, it has been sought the best conditions to accomplish the magic moment of the trading: the expectation negotiation best price, these conditions which comprise the operational modalities, infrastructures, places and appropriate physical spaces and even specialized institutions.

The production results trading has given rise to the direct relation between Purchaser and Seller called “Counter Market” whose basic characteristics are the following ones:

a) Individual Contracts, varying the volume, the quality and other business conditions;

b) Relationships between the parties, not necessarily customized;

c) Mutual Parties Credibility in the contractual execution;

d) Negotiation Privacy and corresponding secrecy;

e) Clearance of the businesses always with the goods physical delivery;

f) Physical, immediate or effective future delivery of the contracted good;

q) Open world market, without determined place or country;

h) Price without public referential, favoring those participants with a bigger and better structure of qualified information; and

i) Negotiation conditions, general rules, under the strongest one's law.

In the evolution of this kind of negotiation the broker appeared. Purchaser and Seller partially lost the command and the control of their own trading, through the loss of direct relationship and of a certain negotiation privacy reduction, besides the own credibility decrease itself between the parties by the broker's interference. Though, the Seller offered his/her products to other Purchasers, breaking the vicious circle of local trading. What was also applied to the Purchasers, thus breaking the captive supplier's protection.

The rescue of the direct relationship between the parties, of the business privacy and the negotiation parties' credibility, keeping the core factor of the performance area coverage, it is indeed accomplished and rendered, through the present System and respective operational methods of businesses processes and of mercantile activities applied to productive sectors.

However, the broker's appearance didn't change the characteristics of the counter market essentially. For a lot of companies, micro, small and medium ones, especially the producer, and even big companies, the coverage of commercial performance from local extent to a regional, national and even international extent is due to the professional broker's presence.

The trading is the terminal end of the whole business administration. All the “entrepreneur's effort” be natural person or legal entity, is addressed to the moment in which the last and unique objective is materialized, natural and expected result of the company, that is, profit.

A new component in the product sale price formulation is the price the market is willing to pay.

The natural consequence of that is the conservative connection especially of the Seller-producer, not following the modernization and use of better negotiation instruments, what means, most of the times, the highest business risk is for the one who indeed produces.

Among the countless problems faced by the production in general, especially agriculture, can be mentioned: low and relatively unstable prices as reflex of a long maturation period from the decision of producing and its real accomplishment, in other words, to plant, harvest and sell, in the case of agriculture, or of installing, producing and selling, in the case of industry; products not differentiated from competitors which allows a plus, in the case of the agriculture; product in primary state, with little or no added value; Purchaser's bargain power, with structure that allows more and better information, access facilities to financial resources and at lower cost, technical-professional support of its “staff”, training and qualification of its professional staff, technological and communication infrastructure; lack of information basic structure and assistance on the market and the prices behavior; deficient and or absent institutional structures, with cooperative system working many times even as Purchaser and competitor; unawareness of uses and resources provided by Information Technology in its business as an important instrument for productivity increase and improvement of competition in a highly globalized market; overcome deficient commercial structure in terms of agility, speed, efficiency and reach; structure absence that enables the assembly of efficient operational engineering, that includes production engineering as well as business engineering and, also, the financial engineering, in an integrated way faces of the same coin and no longer dissociating one from the other; difficulty of obtaining plurality of purchase offers for its production, generator of healthy, challenging and dynamic competition, for the restricted commercial performance.

The current production panorama, including agricultural, worsened a lot in the third world countries, presents as basic characteristic a structure of viced price formation structure, direct consequence of the inefficient trading and of inadequate and insufficient financing put into practice, because it is given priority to the financing to the detriment of the trading.

The production, initially through agriculture, as mentioned, moved in a natural way into the organized markets with the currency appearance, facilitator of agricultural goods distribution originating the market mercantilization with the sale and purchase of goods, emerging, then, the first indications of an organized market.

The following step was the centralized markets: concentration of offers in auctions or floors, aiming at the best natural price for Seller and for the Purchaser, at the business act. The offer plurality, on both sides, results in healthy competition: market natural solution and, therefore, enhancing and accelerating the negotiating processes and natural formation of prices of any good, reducing and or even eliminating the possible price manipulation. Consequently, The Mercantile Exchange was created.

The two negotiation forms accomplished at the Market of Counter and in the Mercantile Exchange Market, have been together with the prevalence of Counter Market for several reasons, point out:

a) Stock holders' mechanisms inefficiency, owing to not following the market new needs, generating distance from the main users, client companies, Purchasers and Sellers;

b) Preference of the big Buying company, in the absence of an efficient offer centralization mechanism, for the Counter Market, through which one can take the best advantage of its organization and concentration; and

c) Brokers' alliance, transforming the Mercantile Exchange into a feud itself, in detriment to other market segments, especially the production trading representatives, main reason for the Mercantile Exchange.

The Mercantile Bond is the appropriate Juridical Instrument for the Production trading for any one of the modalities, in the Counter Market such as Mercantile Exchange Market, anywhere in the world, both being part of which has been conventionally called Physical Market.

In that physical market the mercantile negotiations are always processed with the effective delivery (physical) of goods. It is a very wide market, holding a varied range of forms, types and business modalities.

Comparative chart of the main negotiation characteristics in:

| Mercantile Exchange Negotiations | Counter Negotiation |
|---|---|
| Transparent, spread out and public. | Private, reserved and concentrated. |
| Open information, disclosed to the | Privileged information, exclusive |
| market before, during and | to some parties. |
| after floors. | |
| Pre-established rules and standards. | Free rules. |
| Equal rights and obligations. | Law of the strongest one. |
| Offer and demand forces operate | There is no competition. |
| freely. | |
| Transparent prices where the market | Price without referential, |
| itself makes its arbitration. | facilitating artificial and |
| | inadequate business. |
| Disputes sent to | Disputes sent to common Justice. |
| Arbitration Judgment. | Delay and high costs. |
| Quickness and Economy. | |
| Used by the Government for purchase | Abandoned by the Government |
| and sale of governmental stocks. | many years ago, because of |
| | fraud risks. |
| Operated by broker. | Operated by the interested parties |
| | themselves, the Purchaser and the |
| | Seller. |
| Purchase and sale | Purchase and sale offer dilution. |
| offer Centralization. | |
| Determined and exclusive local, with | Local and regional scope. |
| widened performance. | |
| Standard contracts, with rules for | Individual contracts with wide |
| delivery. | conditions. |
| Goods with very specific | Any good. |
| characteristics. | |

As briefly described, the Mercantile Exchanges centralized and organized markets intended the formation of free and transparent prices, by the plurality of purchase and sale offers, with clear and simple rules.

The Mercantile Exchange mechanism, by its conceptual structuring, demands the broker's intermediation, which is the only one able to operate in the floors, as the representative of each one of the parties: Buying or Selling party. With the time, as a scale economy, started to represent both parties, sometimes, even in a same negotiation.

Also with the business volume increase, that practice was compromised by the emotional involvement in two conflicting offers. The biggest hindrance to the broker's role was the occurrence change in the rules, allowing the broker to operate independently.

The organized markets generated the natural process of purchase and sale offer centralization mechanism, that ended in the Mercantile Exchange institution, whose operation was compromised, due to the practices above, becoming an unsuccessful experience in the production physical market goods trading from certain point.

That explains, largely the Exchange institution bankruptcy in the agriculture-industrial physical market products, which never had an experience in centralized markets, owing to lack of expertise and appropriate mechanisms to its operation.

What was seen was the Mercantile Exchange specialization mechanism as future markets, today derivative, which answered the market need of price oscillation risk transfer, being constituted in a successful experience in that purpose. It is comprehensible the development of future markets, because being financial mechanisms, its development counted on the financial market competence itself, whose administration has shown efficient and effective in the 20^{th} Century, without any other value analysis.

If to the production goods physical market the Stock Exchange institution was compromised, the purchase and sale offer centralization mechanism remains as a fundamental principle in the trading of those products, because the price formation becomes more correct and perfect, in the same purchase and sale offer proportion plurality, with the prices seeking the most appropriate level for the parties. It is what is considered the fair price at the negotiation time. Another important aspect in that purchase and sale offer centralization mechanism is the liquidity increase provided by it, that is, the increase of businesses volume this centralization mechanism offers, by the big offer concentration that, in turn, it generates automatically, more visibility for the negotiated good and the business itself.

### INVENTION BRIEF DESCRIPTION

CNS and respective operational methods, object of the present patent, adds substantial qualitative values to the productive market, that is, to the essence of the nature of what one wants to transform for better, in the human being's benefit and the society itself in its whole.

And, yet, stimulates and potentializes the Production, acting on the final stage of the productive process, that is, the trading, using the Information Technology modern solutions, through systems and electronic means based on market patterns, such as: Internet, Extranet and or Intranet, and respective set of aggregated resources, all necessary to access, data processing and communication and business information, based on an interactive business transaction, online in real time of the most different goods, Assets, Products and Services of the most varied productive sectors, therefore, with the multi-sector types, facilitates the access of any company, of any size, not only the big ones, as especially the micro, small and medium companies, both by the connection facility of each one of them with its market, as well as by the formation, training and BDAs qualification.

The referred BDAs, in turn will be the business community qualification forming agents, including and mainly, focused on the help, support and on CNS's customer's qualification, of the new entrepreneur for the use of the present System and on the formatting and assembling of operational engineering (the company's business ones plus the financial ones) of global business foster of improvements and increase of productivity and competitiveness, propeller of job opportunities, profitability and distribution of income and wealth.

Those BDAs, professionals of the most varied sectors, with experience, and successful as bank executives, executives of “business companies”, agricultural engineers, economists, commercial representatives, administrators, stock, goods and insurance brokers, among others, will be duly trained and qualified by the present System, being recruited whenever there are production, trade or consumption. They will be interlinked and permanently and instantly accessing a Businesses Operation Intelligence Headquarter in each country in the System through an electronic net of information processing and communication via Internet, Extranet, and or, also, via own Intranet, online in real time.

The present System also proposes, a structure that contemplates the mentioned institutional aspect, with the creation of Private Standardization, that grants reliability and credibility to the System.

This System allows within third world countries, the micro, small, medium and big companies to be qualified and equipped with the absorption of advanced, dynamic and up-to-date technologies, appropriate to its businesses; the adoption of the best business practices and the establishment of an updated and modern professional business administration, in an appropriate, way to the challenges which appear and which meet, this way, the trading process which is inserted in the global business context, eliminating phases in the insertion process of a company in a world with negotiation which is getting more and more volatile, selective, demanding, competitive and quicker.

The developed countries will find business partners prepared for the economy global development with immediate and long lasting in the humanity's largest process: The Civilization one.

The present System and respective methods are constituted of a centralized operational structure, integrated and dedicated to the specialized services rendering oriented to production development and the productive sector mercantile activities optimization, where the structure:

a) Offers a virtual centralized place, where Purchasers and Sellers meet, in an electronic way, to carry good purchase and sale offer businesses, regardless physical location and the geographical coordinate where they are;

b) Makes available organized forms of tangible and intangible good purchase and sale offer centralization;

c) Uses suitable business models to each productive sector, be of agricultural, mineral, energetics, industrial, commercial, services, scientific, cultural, intellectual or sports area, among others, belonging to the primary, secondary, tertiary or quaternary market;

d) Uses for that, as Juridical Instrument of negotiation, guaranteed Mercantile Bonds representative of goods, effectively substanced in goods, with specific legislation and formed jurisprudence, dealing with and effective Mercantile Contract of purchase and sale between the Purchaser and Seller;

e) Operates all mercantile negotiations on an advanced and safe technological platform, in line with the state of technique and with the tendencies of Information. Technology, in all their aspects: technical, operational, functional and commercial;

f) Supports a pre-established group of standards, patterns, procedures and highly specialized services, accomplished and established by self-regulation, which govern all negotiations of goods purchase and sale offers, granting them high credibility and operational integrity, everything through Private Authority, the Institute of Mercantile Standards—IMS one or more for each country or market.

g) Makes available and integrates, in a harmonious and interactive way, online—in real time, a set of auxiliary services offered to production agents, the micro, small, medium and big companies, aiming at endowing them with an operational infrastructure and with a business apparatus appropriate to the globalization times, with the operational cost reduction, becoming equally accessible to all participants;

h) Models, intelligently, all processes, considering the context reality of each economical-productive segment, focusing them in the goods negotiation and, therefore, taking into account the bigger interests of Purchasers and Sellers, supplying them means and appropriate forms to optimize its trading;

i) Makes the natural connection between the Productive Market and the Finance Market through the creation of an Asset Business System and not of Liabilities;

j) Establishes a binary system of market Standardization and Operation, with a healthy and well-structured specialization function;

k) Provides a business qualification process by the availability to the market, of a BDAs board duly trained, qualified and highly specialized to help in company's operational engineering assembly the business and financial ones. These BDAs are not brokers, but Business Consultants;

l) Processes the whole System modeling aiming at the privative administration of offers and purchase and sale negotiations and, exclusively, by the interested companies themselves;

m) Introduces the Good Record, where each good negotiated in the System is identified in a unequivocal and a univocal way and has been registering in its profile, an always updated of characteristics and meticulous intrinsic values described in full detail and specified, facilitating and unifying the Purchasing and Selling parties understanding in the negotiations, eliminating ambiguities that harm or take to doubts during the negotiation;

n) Presents, in a graphic and textual way, the “genealogy” of each good taken-to negotiation, through trees and relationship branches, ascending and descending, that identifies its nature, the productive chain in which it is inserted and the economical segment to which it belongs to, besides other important relationship attributes which are also related to it, such as: standards, rules and associated procedures, as well as the geographical area of its production, helping the Purchasing and Selling Parties with the negotiated good correct understanding and visualization, be by the ambiguities elimination inherent to its correct identification, from the most to the least possible abstraction degree in the transformation chain and vice-versa, be by the elimination of existing subjectivities on the good correct definition object of negotiations, this universe, made of countless set of good items of technical, operational and commercial specifications;

o) Provides “continuous education” a system to users, through real time online access to rules, standards, procedures and services and to developed orientations and kept dynamically by Standardizer (Private Authority), therefore, by the market itself, through self-regulation;

p) Stimulates the real national income increase of countries through the guaranteed issuance of Mercantile Bonds of real assets, as are the Production ones; and

q) Allows a conscious and appropriate participation of the financial sector, seeking the production of productive market.

Some advantages brought by the present CNS to the productive sector and to trading processes are: purchase and sale offer centralization operated by the interested parties themselves, which are the Purchasers and Sellers; offer virtual centralization, connecting all interested parties, through facilities provided by Information Technology, not mattering where they are located and at what time. The market, through good purchase and sale offers, is brought inside the company; negotiation public and transparent operation, however, preserving the privacy of the offering Purchasers and Sellers; the interested party itself configures and defines its operational profile, receiving automatically all information and offers in agreement with his/her specified profile, only administering what is of his/her interest; negotiation opportunities absolutely equal among all the participants, thanks to the special purchase and sale offer process modeling elaborated so as to respect automatically and strictly the offer chronology; establishment of the System negotiation Standard Time similar to Greenwich Mean Time, even aiming at equalizing electronically the response time to offers and negotiations, eliminating the delay time caused by communications, even fractions of thousandth of seconds, so as to allow the same opportunity to all the System operators, in any part of the world; technological connection, under any market operational standard, be it accomplished through Internet, Extranet or Intranet through connections and loops of any nature; new and appropriate financial resources sources for production through the issuance of Mercantile Bonds representative of their marketable goods; working capital obtaining by the most appropriate way for the productive company, that is the production premature sale, that is, selling before and producing later, possible by the physical reliability and safety attributed to negotiations within the System; the opening of new domestic and international markets, by the company's global horizon enlargement; reliability and credibility to negotiations by structuring of a warranty system that reinforces the trading of companies in global negotiations; natural bridge between the productive amongst itself and from these with the finance market, through the business modality of business relationship “business-to-business to financial and insurance market”, or simply “B2F” or “B2BF”, conceived, developed and established by the now petitioner, through the System now requested, virtual place of negotiation with credibility in which the Mercantile Bonds will be made available and negotiated; user international digital authentication and certification, operations and goods participant of the negotiations; purchase and or sale decision to the will and of each Seller and or each Purchaser, accomplished without waste of time, thanks to the specific modeling focused on business; real time online negotiation possibility, through a “sui generis” discussion mechanism and direct understanding between the Purchasing and Selling parties, via interactive chat, avoiding the intermediation and motivating the Negotiation Agent's orientation; visualization of negotiated goods through dynamic and or static images, in formats recognized as market standard, important resource, mainly in the operations of trading of industrial goods.

Negotiation Comparison the Mercantile Exchange, Counter and the present CNS now required:

| Mercantile | | |
|---|---|---|
| Exchange Negotiation | Counter Negotiation | CNS Negotiation |
| Transparent, spread out and | Private, reserved and | Transparent, spread out and public. |
| public. | concentrated. | |
| Open information, | Privileged information, | Preserved Privacy of |
| disclosed for the market | exclusive to the parties. | participants. |
| before, during and after | | |
| trading. | | |
| Pre-established rules | Free rules. | Rules and standards pre- |
| and standards. | | established through a |
| | | self-regulating system. |
| Equal rights and | Law of the strongest one. | Equal rights and |
| obligations. | | obligations, with “on-line” |
| | | real time access to rules. |
| Transparent prices | Price without referential, | Prices with referential in |
| where market itself | facilitating the artificial | all offered qualities. |
| makes its arbitration. | businesses. | |
| Disputes are sent to | Disputes are sent to | Disputes are sent to |
| Arbitration Judgment. | Common justice. Delay | Mediation and, if |
| Quickness and | and high costs. | necessary, to Arbitral |
| economy. | | Judgment, with online |
| | | analysis and decision and |
| | | full access to the parties. |
| Used by the | Abandoned by the | Can be used by the |
| Government for | Government years ago, | Government, including for |
| Purchase and Sale of | because of fraud risks. | consumption material |
| governmental stocks. | | purchase. |
| Operated by the broker. | Operated by the | Operated by the |
| | interested parties | interested parties |
| | themselves, the | themselves, including |
| | Purchaser and the Seller. | Purchasers and Sellers, |
| | | Pension and Financial |
| | | Funds. |
| Purchase and Sales | Purchase and sale offer | Wide purchase and sale |
| offer concentration. | dilution. | offer centralization, in |
| | | advanced technological |
| | | platform. |
| Exclusive and | Local or regional scope. | Market with global |
| determined local with | | effectiveness in virtual |
| wide performance. | | space. |
| Goods with very specific | Any good. | Any good, previously |
| characteristics. | | specified and filled for |
| | | wide disclosure. |
| — | — | Operates with Mercantile |
| | | Bonds of Service |
| | | Rendering; Industrial |
| | | Products; Environmental |
| | | Products. |
| — | — | Makes available ancillary |
| | | services integrated to the |
| | | business system and |
| | | offered to the interested |
| | | parties. |
| — | — | Mercantile Bonds totally |
| | | adapted to the Financial |
| | | Market, making the |
| | | natural connection |
| | | between the two Markets. |
| — | — | Support structure focused |
| | | on the negotiation and on |
| | | the management of |
| | | Purchaser and Seller. |

### DRAWINGS DESCRIPTION

To complement this description so as to obtain a better comprehension of the present invention's characteristics, and according to its preferential practical achievement, enclosed here is the schematic drawings set, where, in exemplified manner, though not limited to it, the following has been represented:

FIG. 1: illustrates a graphic idealized to show the main components, integrating parts of this innovating System;

FIG. 2: shows the basic structure necessary to the conformation of this System;

FIG. 2A: illustrates a synergy flux of the specialized agents in this System;

FIG. 3: graphically illustrates a referential and functional definition of the System;

FIG. 4: illustrates a flux chart of the technological and business platform that requites the System;

FIG. 5: is a diagram presenting the selling negotiation System;

FIG. 6: presents the System through a first operating method for commercial transaction through a business specialization flux;

FIG. 7: exemplifies in details the operating method applied to the register flux of a selling intent through this innovator System;

FIG. 8: exemplifies in detail the operating method applied to a launching flux of a selling offer through the System;

FIG. 9: exemplifies in details the operating method applied to the register flux of a purchasing intention into the System;

FIG. 10: exemplifies in details the operating method applied to the launching flux of a purchasing order through the System;

FIGS. 11 & 12: show, through a block diagram, the issuance and register of a Mercantile Bond process and the distinct phases in its negotiation, respectively;

FIG. 13: is an illustrated diagram of the warrant and security system inherent to the operational system presented hereby.

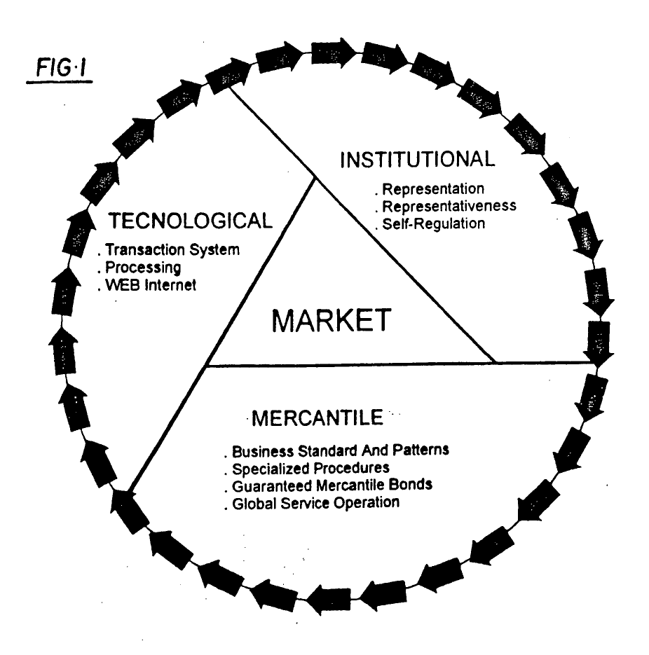

As referred to the presented drawings, this invention refers to a new “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, Private System particularly developed to encourage the mercantile, economical activity and the competitiveness of productivity sectors: agricultural, mineral, energetics, industrial, commercial and services. This System uses adequate technological instruments and access electronic, processing and communication system (Internet, Intranet, Extranet, among others) of data and mercantile, business, operational and commercial information, integrating the productive sector between its various segments and these ones with the financial sector.

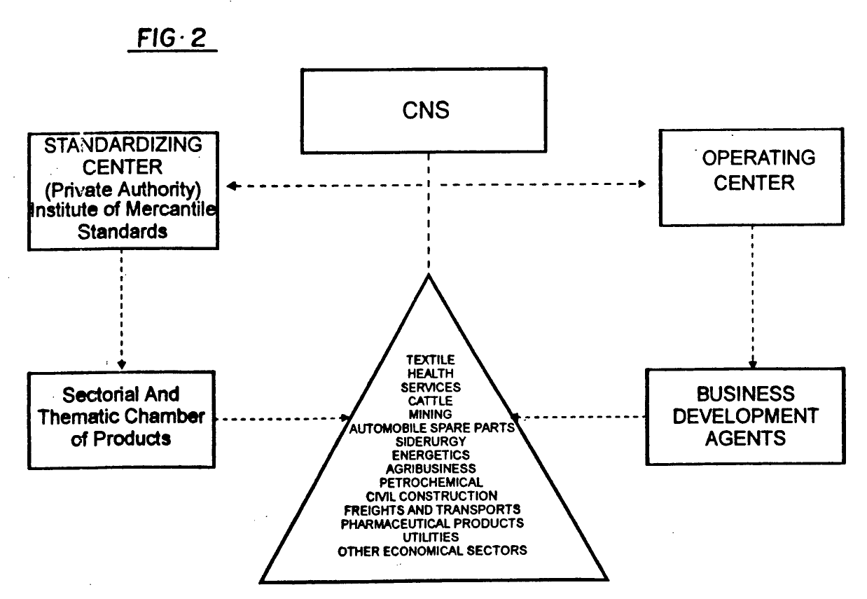

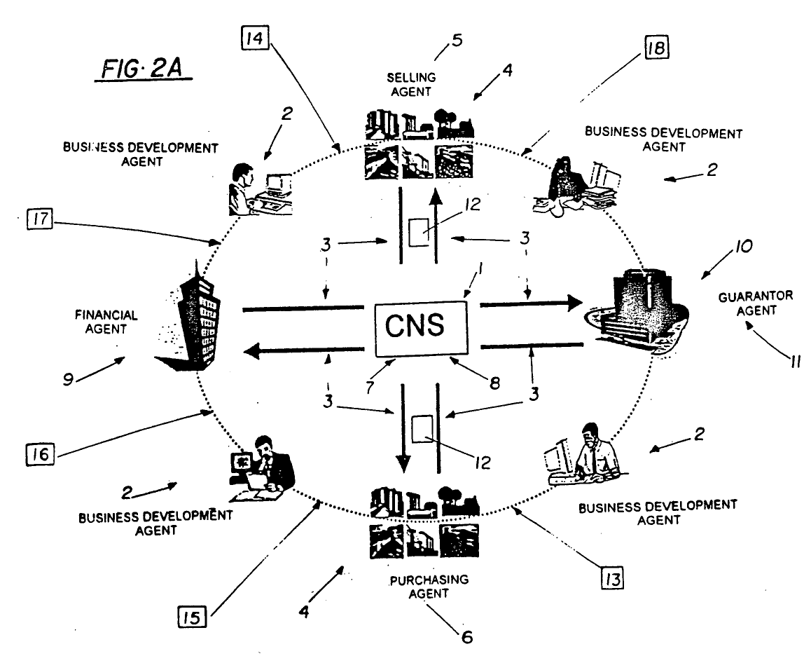

This business operational system, according to FIGS. 2 and 2A, presents a basic structure made up by the Centralized Negotiating System—CNS (1), subject to act over the BDAs (2) and at the same time be interlinked, by technological means and access electronic systems, processing and communications (3), to the Productive Market Institutions (4) formed ideologically by Selling agents (5) and Buying agents (6), being that all this interlinking is self-regulating by Private Authority (7) and an Operating Center (8), using the Financial Institutions (9), especially Banks and Insurance Institutions (10) that, together with banks, act as warrantor (11) of the Mercantile Bonds issuance by the Purchasing and Selling agents (12), once these warrant forms and other forms are previewed for the settlement of these Mercantile Bonds.

The CNS (1) is a market administrator and regulating organ, for the transactions and services, being that, to reach its aims, is based upon its administering action at two levels, that is the operating structure and the administration and services structure.

The Operational structure is composed of:

a) The Purchasers (6), Sellers (5) and other users of its services as a basis for this structure;

b) The BDAs (2) in turn shall be responsible for the register of the Customers (Purchasers and Sellers), for the detailed information to these ones on the rules and regulations of CNS (1), product specification, documentation to be prepared before the each transaction has been carried out as well as CNS's services availability;

c) The representative Associations to the enterprising classes (13) as members of the Private Authority, with specific function of congregating the various Production agents at its productive segments and represent CNS in certain activities and its respective operating areas;

d) The Financial Institutions (9), linked to CNS, for being the financial process manager of the operations;

e) The Mercantile Bonds and operations Warrantors (11);

f) The Store Keepers (15);

g) The Carries (16); the Classifiers and Certifiers (17); and

h) The mediators and Arbitral Judgements and other service renderers.

The Administering and Services Structure uses two secondary basic structures, they are:

a) The Private Authority (7), with the function of ruling, regulating, accrediting and arbitrating the market; and

b) The Operating Center (8), with the function of service renderer to enable the market operational functioning.

The following functions are up to the Private Authority (7):

a) Rule the various markets through the rules, circular, agreements and standard documents, communications, and other rules and procedures;

b) Make accomplish its rules through certificates, notifications and penalties;

c) Direct all the institutional, strategic and political relationship process;

d) Accredit the agents directly involved in the operations, e.g., the enterprising class representative Associations, Financial Institutions, BDAs, Mediators and Judges (group of professionals from the market qualified by CNS, to be pointed by the Purchasing and Selling parts, when there is a conflict to be solved), Classifiers, Certifiers, Store Keepers, Auditors, among others;

e) Standardize the negotiation forms of goods (assets, products and services), aiming the information transparency and the quickness of transactions, using whenever possible preexisting rules defined by national organs, mainly, by international organizations such as: International Standard Organization—ISO, World Trade Organization—WTO, International Chamber of Commerce—ICC, Small Business Association—SBA, and others;

f) Register agreements, Mercantile operation Bonds and their warranties, certifying these registers and presenting managerial reports on them;

g) Judge the business disputes through Arbitration Judgements or mediate disputes through the market system; and

h) Settle dispute of quality, quantity and the good states, Assets, Products and Services, through classification systems and accredited auditioning; certify, accredit and evaluate enterprises, Mercantile Bonds, market and warranties through analysis systems.

The following matters are up to the Operating Center (8):

a) Operate the negotiation and commercial operation register system and its reflexes on the administrative and financial areas, conforming with the defined norms by the Private Authority (7);

b) Provide the Market Development through the creation of new products, contacts, Mercantile Bonds, operational and services modalities;

c) Manage the technological support of access, processing and communications of data and market, business, operational and commercial information;

d) Select and accredit the various service, equipment and Information Technology supplier companies, insurance companies, rating analysis, logistics, classification and diffusion of business information;

e) Provide Training and Motivation to the market participants, through courses, lectures and events, especially from BDA;

f) Make institutional and marketing campaigns;

g) Contact and make agreement for bank service aiming at making available financial resources for the users;

h) Accomplish and make accomplish the directions of the Private Authority (7); and

i) Publish the offers and business carried out.

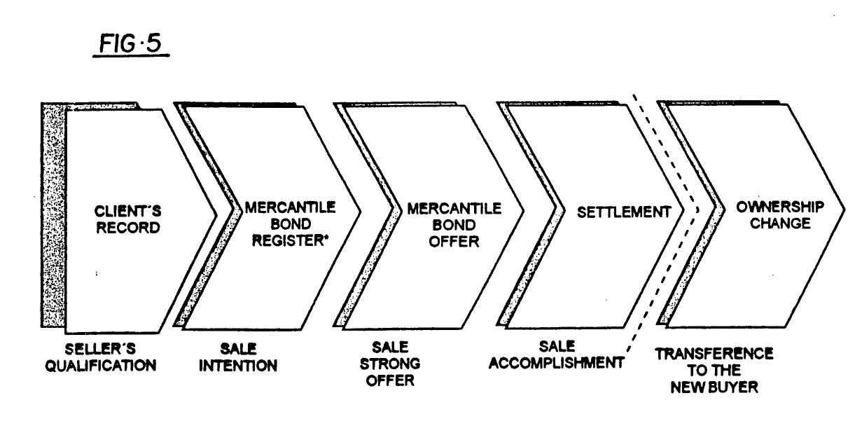

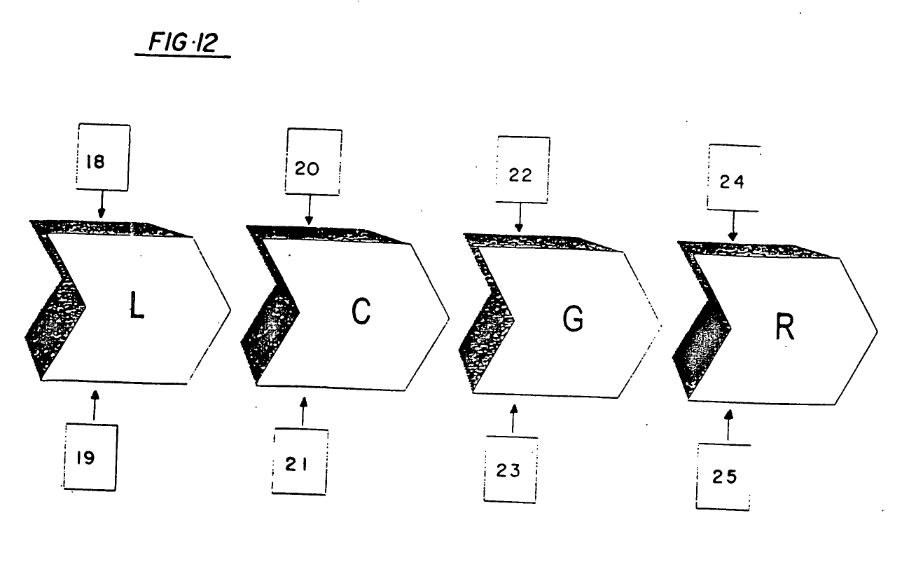

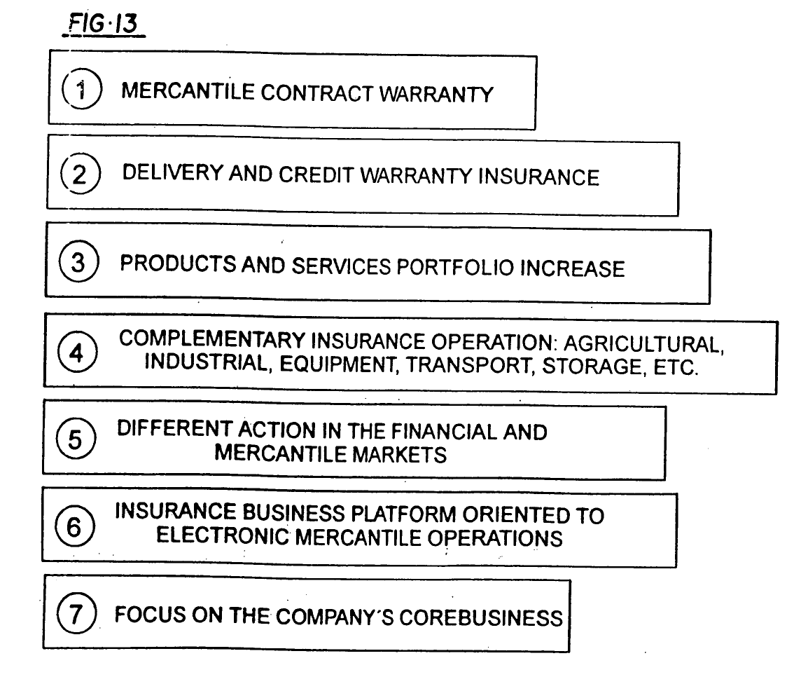

To contribute for a perfect working of this System, it counts on the BDAs (2), whose functions are aimed to the costumer to be filed at CNS, i.e., directs the costumer record, directs the guarantee (see FIGS. 5 and 11), provides the selling of CNS's services and the training and qualification of costumer at CNS, so as to file its goods in the operational system.

When filing the Selling (5) customer in the system (see FIG. 5), the Selling costumer must in turn, prove installed capacity to produce and trade, issuing Mercantile Bond or proposing a sale. He/she sells at the availability or for effective future delivery, receives payment in currency on in cash or beforehand, accomplishing local delivery on time and with the quality agreed.

The Purchaser costumer (6) dully filed in the System, proves business or financial capacity, issues purchase order and pays, receiving the good.

The institutions representative of business classes and or other market institutions (13) agreed with CNS, carry out functions to make available CNS's structure and services in their operation areas, especially those aiming at congregating the various Productions agents in their productive segments (4).

The Financial Institutions (9) have as function to receive, analyze and approve the Seller (5) and Purchaser (6) costumers files, granting operational limits, offering or receiving warranties, analyzing and approving third parties warranties in the operation, accepting and sending granting approval to CNS for the accomplishment of the register of the purchase or sale Mercantile Bond, making the financial management for its costumers for payment and/or receiving corresponding to the negotiation accomplished in the system.

The Warrantor (11), be it a Financial Institution, Insurance company or a Company which offer warranties to the Mercantile Bonds negotiated at CNS, must be qualified by CNS, as well as the forms and levels of warranties that will be fixated by it.

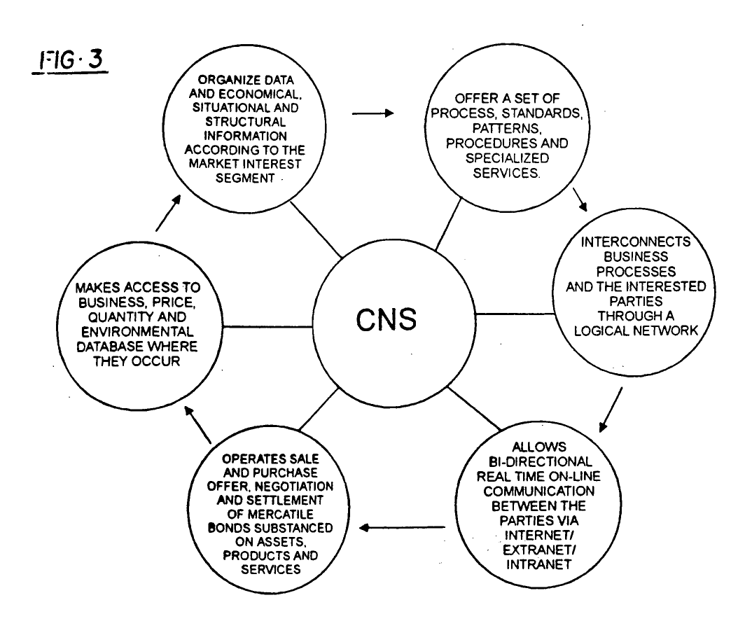

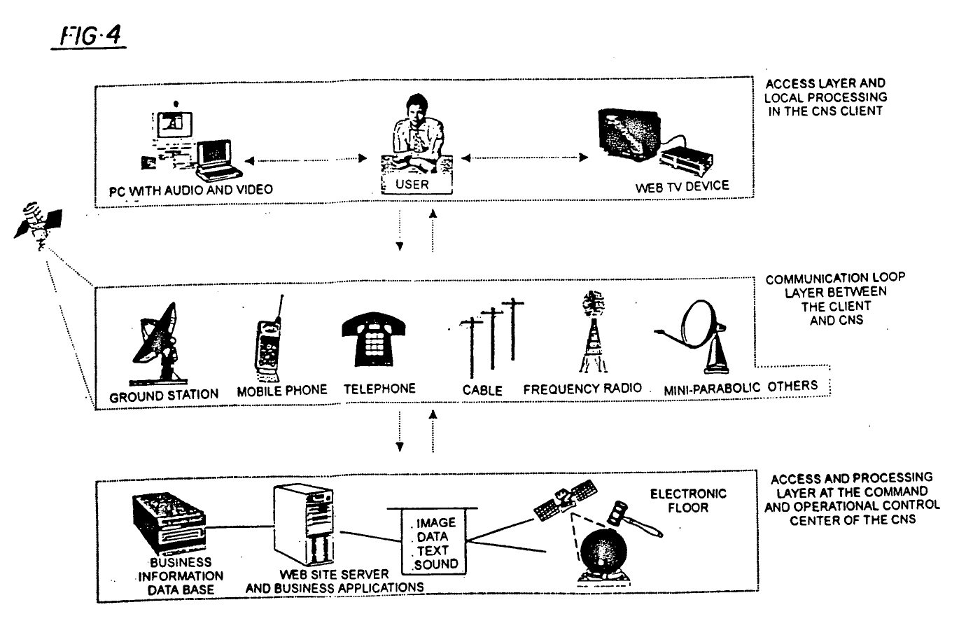

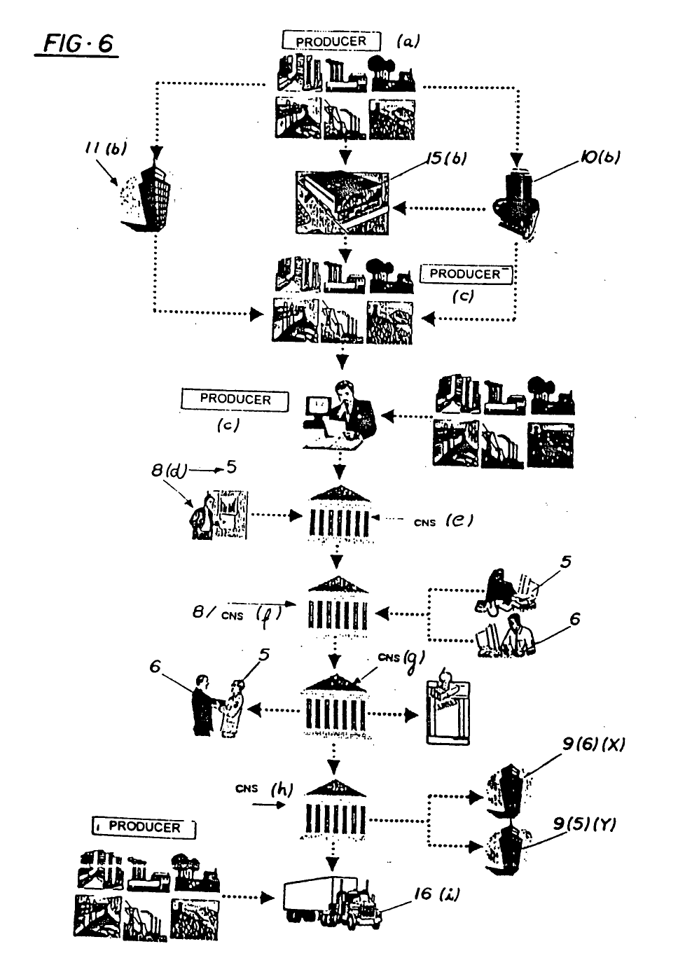

The basic referential operational method (refer to FIGS. 3 and 5) using this System to accomplish a deal (FIG. 6) made through the business specializations at CNS, goes along with the following steps:

a) The Producer, which produces goods, is contacted by BDA (2), which files him/her into the System also aiming at registering the referred goods for selling through the Mercantile Bonds;

b) The Warrantors (11) and the Store Keeper (15) are contacted (if necessary);

c) The issuer Producer issues the scriptural Mercantile Bond;

d) The Producer registers the Mercantile Bond at the Operating Center (8) of CNS to stamp, becoming a Seller (5);

e). The Operating Center consolidates and makes available at the electronic floor the Mercantile Bonds segmented by good, through international coding;

f) The Operating Center, through its technological platform approaches and makes viable the offer and order that occurs directly between Seller (5) and a Purchaser (6), with validity specified between the parties;

g) The Operating Center, in the name of Private Authority, register the settled transaction by the parties based upon product unities issuing probative documents to both interested parties, i.e., Purchaser and Seller;

h) The Operating Center influences the Banks to accomplish the financial clearing of the business, i.e., allows communication between the Purchaser's liquidator bank “x” (paying) and the Seller's liquidator bank “y” (receiving) without any interference from third parties; and

i) The Seller/Producer delivers the goods according to the contractual clauses agreed with the Purchasing party.

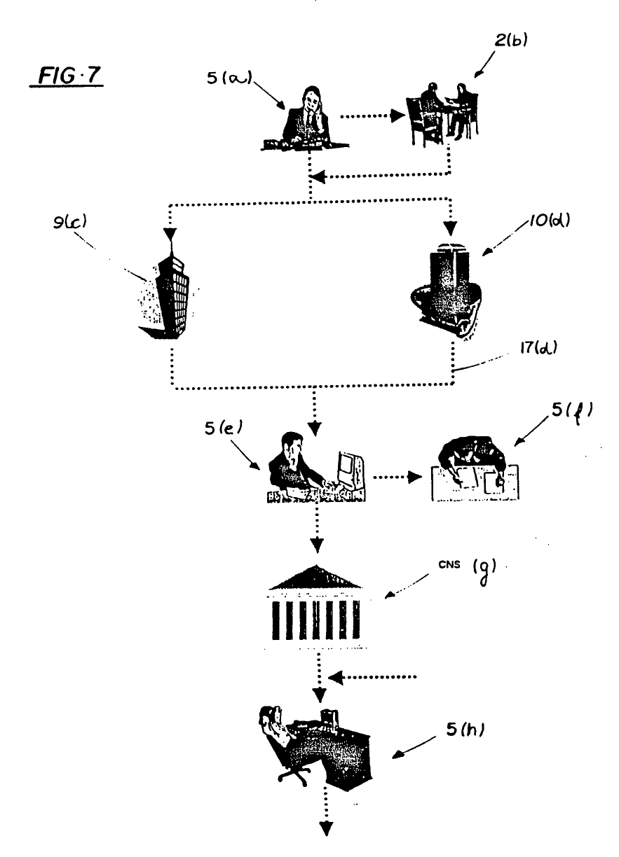

The referential operational methods to generate the register flux of a selling offer intention at CNS (FIG. 7), goes through the following stages:

a) The Seller (5) shows the intention of selling offer;

b) The BDA (2) advises the Seller in the operational engineering (business and financial) and its accomplishment;

c) The Seller (5), through the bank (9) obtains credit and warranties by issuing Mercantile Bonds;

d) The Seller (5) through the insurance company (10) obtains warranties and the warranty certification (17) by the issuing to deed policy by the warrantor;

e) The Seller (5) registers at CNS the “selling offer intention”, containing the pre-sale characteristics and conditions;

f) The Seller makes available the offer of “selling on waiting state” at the CNS, with status indicating those Publishable and Non-Publishable;

g) The CNS carries out the selling intention offer and block the goods stored specified by the Seller in case of prompt delivery contract; and

h) The Seller waits for the most convenient time to output the launching offer release of “selling on waiting state” to “sale” in the CNS's electronic floor.

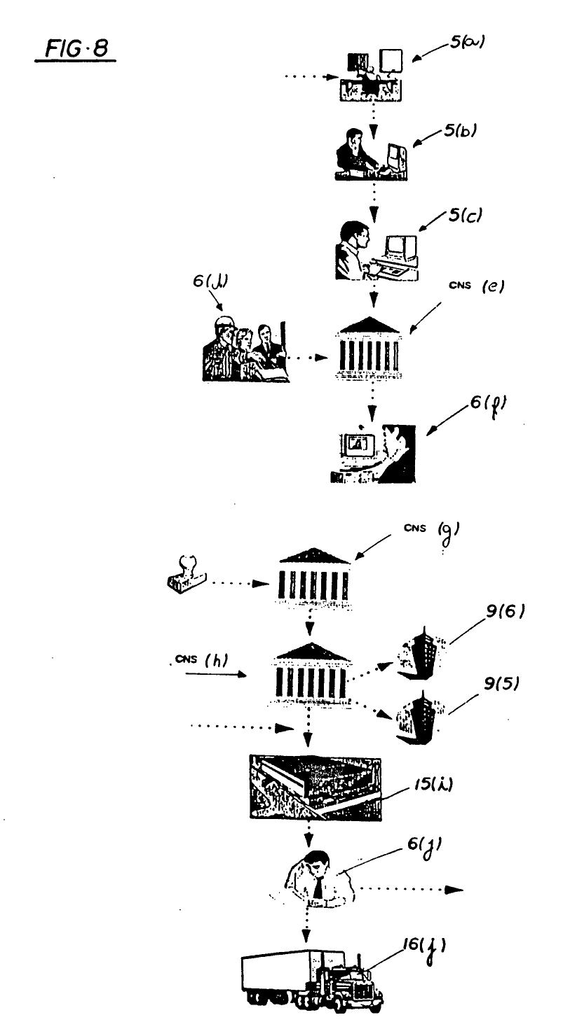

The referential operational method to accomplish the release of a selling offer at the CNS (FIG. 8), goes through the following steps:

a) The Seller (5), from his/her business strategies decides releasing a selling offer for goods, on electronic floor at the CNS;

b) The Seller alters or keeps the characteristics and conditions of the pre-sale;

c) The Seller changes at the CNS the pre-sale offer status to “selling on waiting state” to “sale”, authorizing its admission at the floor as strong offer;

d) The Purchaser (6) settles the negotiation in the original price offered by the Seller or makes the counterproposal if the condition is allowed by the Seller;

e) The CNS makes available the electronic floor;

f) By the arriving order, the Purchaser (6), exercises the buying options by the business conditions established by the Seller;

g) The CNS register the settlement of the business carried out between the parties, with the probative documents issuance for Purchaser and Seller;

h) The CNS notifies the Purchaser and the Seller banks to the financial materialization between the parties;

i) The CNS notifies the store keeper (15) about the good ownership transference in the case of final delivery of the contract; and

j) The purchaser, the new good holder, may release it again in floor or simply receive the good through the carriers (16).

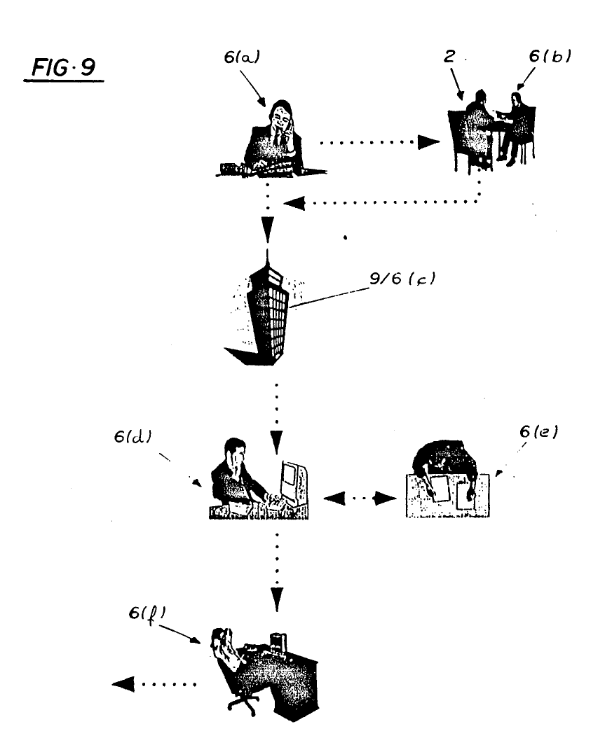

The referential operational method for the registry of a purchasing offer intention flux at CNS (FIG. 9), follows these steps:

a) The purchaser (6) shows intention of making a purchasing offer;

b) BDA (2) advises Purchaser (6) on the operational engineering (business and financial) of business and its accomplishment;

c) Through the Warrantor (9), the Purchaser (6) obtains scriptural credit for payment warranty;

d) The Purchaser (6) register at CNS the “purchasing offer intention”, containing the pre-purchase characteristics and conditions;

e) The Purchaser (6) makes available the purchase offer in “purchase on waiting state” pointing those Publishable and Non-Publishable; and

f) The Purchaser (6) waits for the right time for the liberation of the “purchase in waiting state” offer release for “purchase” at the electronic floor at the CNS.

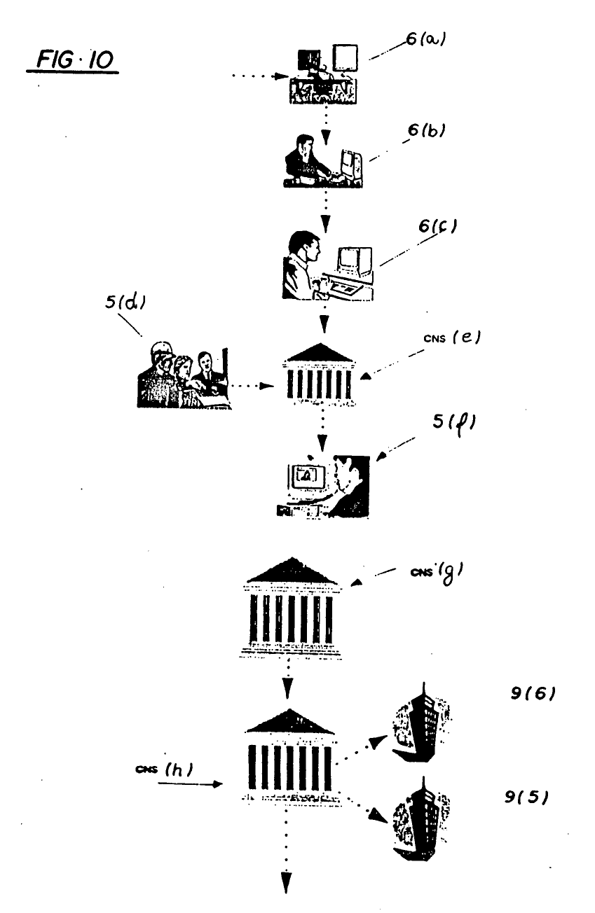

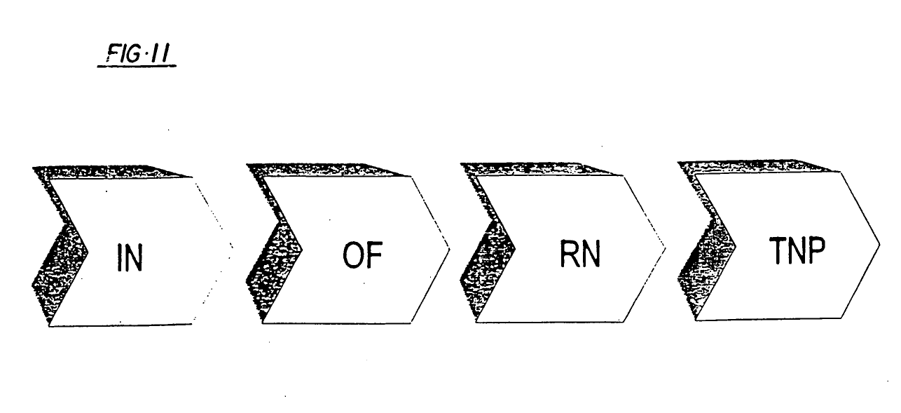

The referential operational method for the accomplishment of a purchasing order release flux through the CNS (FIG. 10), follows these steps:

a) The Purchaser (6) decides to release the purchase offer of goods by electronic floor at the CNS;

b) The Purchaser (6) alters or keeps the pre-purchase characteristics and conditions;

c) The Purchaser (6) alters at the CNS the pre-purchase offer from “purchase on waiting state” into “purchase”, authorizing the entrance into a floor as strong offer;

d) The Sellers (5) accomplish the counter-offer if the conditions is allowed by the Purchaser;

e) The CNS makes the electronic floor available;

f) The Seller (5), through incoming order, chooses the selling options under the business conditions established by the Purchaser;

g) The CNS register the accomplished business settlement between the parties, with the issuing of the probative documents for Purchaser and Seller; and

h) The CNS notifies the Purchaser's and the Seller's banks for the financial accomplishment of the business between the parties.

The Mercantile Bond (12) is the Juridical-Business instrument suitable for the purchase and sale offer negotiation of goods, in CNS, this instrument respecting all Commercial Code lines and Civil Process Code, regulates the matter, whose issuance and negotiation is exclusive to the involved parties, that is, Purchasing and Selling Parties which through the Mercantile Bond, have the command and absolute control of the negotiation.

The Mercantile Bond (FIG. 11) it presents four different phases in its negotiation, which are:

a) Negotiation Intention (NI): Represents the Issuer/Owner (Purchaser/Seller) will to negotiate in CNS the goods object of Mercantile Bond;

b) Strong Offer (SO): Is the goods negotiation offer to the market, through public offer of the Mercantile Bond, through CNS, with the whole compulsory force, from whom makes the offer, clearly foreseen in the legislation;

c) Accomplishment of Business (AB): it is the business settlement, that is, the negotiation acceptance (purchase or sale) of goods, object of Mercantile Bond, from a third party interested in offered good. At this time, the Mercantile Bond is established in a Mercantile, juridical and commercially perfect contract, according to the Law of any country; and

d) Transfer to the New Owner (TNO): This transfer happens, exclusively, by change of Mercantile Bond Possession from the former to the new owner, within CNS, not being admitted the endorsement. This transfer forces the clear identification of the involved parts (Seller and Purchaser), accomplished by proper specific document of the mercantile process.

According to illustration 12, the Mercantile Bond Issuing Process aims at mapping the way it travels in CNS, from the negotiation intention, going by their specifications, goods, amount, price, etc, up to its real register at CNS.

So as the Mercantile Bond Issuance Process can take place, the following steps are necessary:

a) Location (L): it consists of the identification (18) of the place where the goods is or will be stored (19). This identification is accomplished by the issuer of the Mercantile Bond itself, informing the place where it is or and it will be. In case of immediate delivery or in which it will be stored in case of Mercantile Bond for effective future delivery;

b) Classification (C): it consists on the certification (20) of goods as for its quality classification, accomplished by the classifying organs (21) specialized accredited by CNS in each economical segment;

c) Guarantee (G): it consists of assigning a warranty code (22) to the Mercantile Bond enabling the trading of goods that it represents. This activity can be automatic, according to the user's limits, or manual where the warrantor (23), from the Mercantile Bond data, will grant or not the guarantee with the respective code; and

d) Register (R): it consists of the trading intention accomplishment, represented by the registration (24) of the Mercantile Bond for the issuer/negotiator himself/herself (25) and characterized with the information and necessary specifications for the trading of the goods, also defined for the issuer himself/herself of the Mercantile Bond and the registration of a contract settlement.

1st) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, Private System particularly developed to foster, economical mercantile activity and the competition of productive sectors: agriculture, mineral, energetics, industrial, commercial and services; this system which uses suitable access, processing and communication technological and electronic instruments, (Internet, Intranet, Extranet, among others), of market, business, operational and commercial data and information, integrating the productive sector among its several segments and these with the financial sector; the business operational system, called Centralized Negotiation System, hereafter mentioned only as CNS, is characterized by presenting a basic structure formed by a Commercial Transaction Operating Center (1), subject to act on the BDAs (2) and at the same time be interconnected, by access, processing and communication technological and electronic means (3) to Productive Market Institutions (4) formed ideologically by Selling agents (5) and Purchasing agents (6), being that the whole integration is self-regulating, institutionally, by a Private Authority (7) and, managerially, by an Operating Center (8), using the Financial Institutions (9), in special Banks and Insurance Companies (10) and even single Companies which, operate as Warrantors (11) of Mercantile Bonds issuance (12) or other ways of guarantees for the settlement of these Mercantile. Bonds, from the AND board (2) and of a specific set of ancillary services complementary to the carrying out of business operations.

2nd) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the 1st CLAIM, CNS (1) is characterized for being the market administering and regulating organ, of transaction and services, based on its administration in two operation levels, being one referring to the Operational Structure and the other to the Institutional Structure (Private Authority).

3rd) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to previous claims, characterized by the fact that CNS uses the following operational structure:
a) The Purchasers (6), the Sellers (5) and other users of its services as base of this structure;
b) The Business Development Agents—BDAs (2), as consultants of customers and sellers/promoters of the CNS Services.
c) The Associations representative of several business classes and Academic Institutions (13) and other agreed Market institutions, through the Private Authority, with specific functions of congregating the Business Agents (2) and of representing CNS in certain activities in its respective operating areas;
d) The Financial Institutions (9), connected to CNS, by being the managers of the operation financial processes;
e) The Guarantors (11) of Mercantile Bonds and operations;
f) The Store Keepers (15); and
g) The Carriers (16); the Classifiers and Certifiers (17); and other service renderers.

4th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the 1st and 2nd claims, characterized by the fact that the Administration and Service Structure uses two basic complementary structures, they are:
a) The Private Authority (7), with the function of ruling, regulating, registering (Mercantile Bonds and Contract Settlement), accreditng and arbitrating the market in an institutional way; and
b) The Operating Center (8), with the function of business service renderer to enable the operational functioning of the market and its negotiations.

5th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the fact that it's up to the Private Authority (7) the following functions:
a) Rule the several markets through regulations, circulars, standard contracts and documents, notifications, among other rules and procedures, all through self-regulation methods.
b) Make accomplish its rules through reports, certificates, notifications and penalties;
c) Guide the whole institutional, strategic and political relationship process;
d) Accredit the agents directly involved in the operations, such as: Representative Associations, Financial Institutions, Arbitration Judgements (group of market professionals qualified by CNS, to be appointed by the parties, when solving conflicts), Classifiers, Certifiers, Store Keepers, Auditors, Warrantors;
e) Standardize the negotiation way of goods, aiming at the information transparence and the quickness of transactions using whenever possible the pre-existing rules defined by the national certifying organisms and, those international ones, such as: International Standard Organization—ISO, World Trade Organization—WTO, International Chamber of Commerce—ICC, Small Business Association—SBA, among others;
f) Register contracts, Mercantile Bonds operations and its guarantees, certifying these registers and presenting managerial reports on them;
g) Arbitrate the business disputes through Arbitral Judgements; and
h) Settle the disputes of quality, quantity and the goods state through classification system and accredited auditing.

6th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the fact that it is up to the Operational Center (8) the following functions:
a) Operates the business system and register the commercial operations, in the name of the Private Authority) and their reflexes on the financial and administrative areas, and also in compliance with the rules defined by the Private Authority (7);
b) Provide the Market Development through the creation of new products, contracts, Mercantile Bonds, operational modalities and services;
c) Manage the technological support of access, processing and data communication and business, market, operational and commercial
d) Select and accredit the several service, equipment and Information Technology supplying companies, insurance companies, rating analysis systems, logistic, classification and business information diffusion;
e) Provide training, qualification and motivation for the market participants, through courses, lectures and events;
f) Carry out market and institutional campaigns;
g) Inform, especially the BDAs, on the mercantile and financial services aiming at making the financial resources available for the users;
h) Comply and make comply the Private Authority's determinations (7); and
i) Disclose the offers and business carries out in CNS.

7th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the fact that the BDAs functions (2), are related to the client to be filed in CNS, that is, must help, support, qualify and guide the client, send the client's file, orientate the client for the obtaining of Mercantile Bond (12), provide the sale of services made available by CNS for the client and the respective training so as to file its products or services in the operational system, all activities as a Business Consultant, not as a broker.

8th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the fact that the Selling client (5), when being filled in the System, proves installed and business productive capacity, issuing Mercantile Bond or proposing a sale of goods; this sale is carried out for prompt delivery or for effective future delivery, receiving payment in currency in cash or in advance and accomplishing the good delivery at the local, time and quality agreed, always adding a guarantee of delivery.

9th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the fact the Purchasing Client (6), duly filed in the System, proves business or financial capacity, issuing purchase order and paying, receiving the acquired good, always adding a guarantee of payment.

10th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the fact that the institutions representative of Business is and Academics classes and other Institutions (13) agreed with CNS, carry out functions of making available the structures and services of CNS in their operating areas.

11th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to previous claims, characterized by the fact that the Financial Institutions (9) have as function to operate the financing clearance of the CNS making the financial management of its clients and the payment and receiving means.

12th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the fact that the Guarantor (11), is the Financial Institution, Insurance Company or a single Company which offers guarantee to the Mercantile Bonds or operations in CNS, to be accredited by CNS, as well as the forms and levels of guarantees which will be set by it.

13th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the operational method applied to carry out the purchase and sale release flux in CNS follow the steps below:
a) The Seller (5) decides to release sale and offer of goods, Assets, Products and Services, in an electronic floor in CNS;
b) The Seller alters or kept the pre-sale characteristics and conditions;
c) The Seller alters in CNS the “on hold” pre-sale offer status to “sale”, authorizing the entrance in floor as strong offer;
d) The Purchasers (6) carry out the counter-offer if the condition is allowed by the Seller;
e) CNS makes the electronic floor available;
f) The Purchaser (6), by the incoming order, makes the purchase option under the business conditions established by the Seller;
g) CNS registers the business settlement carried out by the parties with the issuance of proving documents for Purchaser and Seller;
h) CNS notifies Purchaser's and Seller's banks for the business financial carrying out;
i) CNS notifies the store keeper (15) on the goods transference; and
j), The Purchaser, new holder of goods, can release them again in floor or simply receive the goods through carriers (16).

14th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the operational method applied for the purchase offer intention flux register in CNS, follow the steps below:
a) The Purchaser (6) shows the intention of purchase offer;
b) BDA (2) helps the Purchaser in the operational engineering (business one plus the financial one) of business and in its accomplishment;
c) The Purchaser (6), through the Guarantor (11), obtains scriptural credit limit for payment warranty;
d) The Purchaser registers in CNS the “purchase offer intention”, containing the characteristics and conditions of pre-sale;
e) The Purchaser makes available the purchase offer with “on hold” “status” indicating those Publishable and Non-Publishable; and
f) The Purchaser waits for the right moment for the purchase offer release in the CNS electronic floor.

15th ) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to the previous claims, characterized by the operational method applied for the carrying out of a purchase order in CNS, follow the steps below:
a) The Purchaser (6) decides to release purchase offer of goods, in electronic floor at CNS;
b) The Purchaser (6) alters or keeps the pre-purchase characteristics and conditions;
c) The Purchaser (6) alters in CNS the pre-purchase offer status “on hold” to “purchase”, authorizing the entry in floor as strong offer;
d) The Sellers (5) make the counter-offer if the conditions is allowed by the Purchaser;
e) CNS controls the electronic floor;
f) The Seller (5), by the incoming order, makes the sale option in the business conditions established by the Purchaser;
g) CNS registers the business settlement carried out by the parties, with issuance of probative documents for Purchaser and Seller; and
h) CNS notifies the Purchaser's and Seller's banks for the business financial carrying out of the accomplished business.

16th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to all previous claims, characterized by the Mercantile Bonds (T) to be the appropriate Juridical-Business Instrument for the offer negotiation, CNS purchase and sale, which regulates the subject, whose issuance and negotiation is exclusive to the parties involved, that is, the Buying party and Selling party, on which the Mercantile Bond has absolute negotiation command and control.

17th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to claim 16th, characterized by the Mercantile Bond Instrument, present four different phases in its negotiation, they are:
a) Negotiation Intention (IN): Represents the Issuer's/Owner's will Purchaser/Seller) to negotiate in CNS the good object of the Mercantile Bond;
b) Strong Offer (OF): Is the goods negotiation offer to the market, through public offer of Mercantile Bond, through CNS, with all obligation force, from whom makes the offer, clearly foreseen in the legislation;
c) Business Accomplishment (RN): Is the business settlement, that is, the negotiation acceptance (purchase and sale) of goods, object of the Mercantile Bond, from a third party interested in the offered good. At this moment, the Mercantile Bond is established in a Mercantile Contract, juridical and commercially perfect and finished, according to the Law of any country; and
d) Transfer to the New Owner (TNP): This transfer occurs, exclusively, by the change of ownership of the Mercantile Bond from the former to the new owner, within CNS, not being admitted the endorsement. This transfer forces the clear identification of the involved parties (Seller and Purchaser), carried out by suitable document specific to the mercantile process.

18th) “CENTRALIZED NEGOCIATION AND OFFER SYSTEM AND RESPECTIVE OPERATIONAL METHODS OF OFFER, BUSINESSES AND MERCANTILE ACTIVITIES PROCESS APPLIED TO PRODUCTIVE SECTORS”, according to claim 16th, characterized by Mercantile Bond Instrument, follow the steps below to allow the Issuing Process of the referred Mercantile Bond:
a) Localization (L): consists of the identification (18) of local where the good is stored. This activity is carried out by the depositary itself (19) (issuer). In case of Mercantile Bond for immediate delivery or in which it will be stored in case of Mercantile Bond for effective future delivery;
b) Classification (C): consists of the good certification (20) as for its classification, carried out by the classifying organs (21) specialized of each economical segment;
c) Warranty (G): consists of assigning a warranty code (22) enabling the good trade. This activity can be automatic, according to the user's limit, or manual where the warrantor (23), from the Mercantile Bond data, will grant or not the warranty with the respective authorization code.
d) Register (R): consists of trading intention execution, represented by the register (24) of Mercantile Bond by the issuer/negotiator himself/herself (25) and characterized with the information and specifications necessary for the trading of goods, also defined by the Mercantile, Bond issuer himself/herself and the registration of the contract settlement.
